(19) United States
(12) Patent Application Publication
(10) Pub. No.: US 2026/0008621 A1
(43) Pub. Date: Jan. 8, 2026

(54) BASINS FOR OIL STORAGE

(71) Applicant: Abu Dhabi National Oil Company, Abu Dhabi (AE)

(72) Inventors: Abdelwahab NOUFAL, Abu Dhabi (AE); Khalid OBAID, Abu Dhabi (AE)

(73) Assignee: Abu Dhabi National Oil Company, Abu Dhabi (AE)

(21) Appl. No.: 19/111,914

(22) PCT Filed: Sep. 16, 2022
(86) PCT No.: PCT/IB2022/058771

§ 371 Date: Mar. 14, 2025

(51) Int. Cl. B65G 5/00

(52) U.S. Cl. CPC B65G 5/00

(57) ABSTRACT

The present disclosure is directed to an oil storage, wherein the oil storage comprises at least one basin for receiving oil, and a salt dome that penetrates to the surface of the earth, wherein the basin is formed into a surface of the salt dome which is at the surface of the earth.

### 1. TECHNICAL FIELD

The present disclosure relates to an oil storage and a method for developing an oil storage.

### 2. PRIOR ART

At least since the 1973 global oil crisis, the importance of stockpiling oil reserves has been widely recognized and practiced by most nations. These oil reserves are used to bridge a country's potential short-term oil supply shortfall. In this regard, in many nations, oil stockpiling is even regulated by law because of its importance to the national economy. However, oil reserves are not only used to bridge a country's potential short-term oil supply shortage, but also to allow oil producers to compensate for temporary overcapacity and/or production shortfalls.

Various aspects play a role in the selection of a suitable oil storage. For example, in addition to the capacity, the effort required to manufacture and/or maintain the oil storage, the ability to retain oil permanently and safely for future use, as well as the speed at which the oil can be withdrawn, are decisive.

Multiple types of oil storages are known from practice. However, the existing oil storages have different disadvantages as described in more detail below.

Often, oil such as crude oil, is stored in steel tanks. Steel tanks are particularly preferred for short term storage, e.g. to allow oil producers to compensate for temporary overcapacity and/or production shortfalls. In particular, steel tanks can be integrated into production equipment/pipeline systems to avoid supply interruptions during maintenance and/or emergency shutdowns.

However, steel tanks are often complicated in both manufacture and installation, costly, and/or difficult to maintain due to corrosion over time. In addition, there is a technical limitation of storage capacity particularly due to manufacturing limitations and/or material availability.

Therefore, natural oil storages are often used, especially for higher storage capacities as required for strategic oil storage, to avoid the above-mentioned disadvantages of steel tanks. Around the world, oil is stored naturally using a variety of different natural oil storages. For example, oil is stored in depleted oil and/or natural gas fields, aquifers, and/or salt cavern formations.

However, these natural oil storages also have various disadvantages. Exemplarily, the above-mentioned natural oil storages are located underground, so that efforts are required to bring the oil to the surface of the earth for further use and/or transport. Thereby the speed at which the oil can be withdrawn is limited, particularly when compared to above-earth steel tanks. In addition, an underground infrastructure must be provided to allow for filling and/or depleting the oil storage. Further, another problem with underground oil storages is that they must be prevented from collapsing, also to avoid environmental disasters. Moreover, the construction of underground oil storages is often technically complex and therefore expensive and/or time-consuming. Even further, it has shown that the inspection of existing natural oil storages is often complicated.

Thus, in view of the above, it is an object of the present disclosure to provide an oil storage and a method for developing an oil storage that overcome the aforementioned drawbacks at least partially.

### 3. SUMMARY OF THE INVENTION

This object is achieved, at least partly, by an oil storage and a method for developing an oil storage, as defined in the independent claims. Further aspects of the present disclosure are defined in the dependent claims.

In particular, the object is achieved by an oil storage. The oil storage comprises at least one basin for receiving oil, and a salt dome that penetrates to the surface of the earth, wherein the basin is formed into a surface of the salt dome which is at the surface of the earth.

Salt domes are the best-known form of geological salt structures. Particularly, salt domes are a type of structural domes which may be formed when salt or other evaporite minerals intrude into overlying rocks in a process known as diapirism. Salt domes may be discovered using techniques such as seismic reflection.

As is commonly known, the surface of the earth is the interface between the earth's solid crust, including soils and waters, on the one hand, and the atmosphere on the other. Hence, it is understood that the surface of the salt dome into which the basin is formed may also represent a part of the surface of the earth. Further, the surface of the salt dome which is at the surface of the earth may be also referred to as uncovered surface of the salt dome.

Said oil storage has various advantages, particularly compared to the above-described prior art solutions, wherein four of them are exemplarily lined out in the following.

First, it is possible to achieve large storage capacities with reduced expenditure of time, material and/or labor, particularly compared to the prior art solutions. Exemplarily, compared to the above-described steel tanks the oil storage according to the present invention does not require the installation of large containers made of steel. Further exemplarily, different from existing natural oil storages no deep-reaching underground infrastructure must be provided to allow for filling and/or depleting the oil storage.

Second, the oil storage according to the present invention is less difficult to maintain compared to prior art solutions. Exemplarily, compared to the above steel tanks corrosion does not need to be monitored. Further, different from existing natural oil storages the oil storage according to the present invention does not need to be prevented from collapsing.

Third, the oil storage according to the present invention allows for a relatively high speed at which the oil can be withdrawn, particularly when compared to existing natural oil storages. In detail, as above-mentioned, the existing natural oil storages are located underground, so that efforts are required to bring the oil to the surface of the earth for further use and/or transport what limits the speed at which the oil can be withdrawn.

Fourth, the inspection of the oil storage according to the present invention is facilitated, particularly when compared to existing natural oil storages which are regularly located underground.

Even if it is not always explicitly stated, the advantages mentioned by way of example also apply to the following.

The at least one basin optionally was formed by mining and/or washing out. “Mining” in this context may include the use of excavators, blasting, cranes, manual digging, strip mining, open-pit mining, and/or other mechanical excavation methods. “Washing out” in this context may comprise using liquids such as water to wash out the at least one basin. Mining may be preferred in regions where water is unavailable or limited. Washing out on the other hand can be advantageous when the use of equipment for mining is difficult. For example, in terrain that is difficult to access. Hence, in summary, oil storages according to the present invention may be created in areas that are difficult to access and/or dry. It is understood that mining and washing out may be combined.

A maximum depth of the at least one basin measured from the surface of the earth may be in a range from 2 m to 50 m, optionally from 5 m to 30 m, and further optionally from 10 m to 20 m. First, it was found that basins with these depths are relatively easy to realize, especially compared to existing natural oil storages e.g. based on underground caverns. Furthermore, it has been shown that these depths on the one hand allow for capacities that are sufficient for most applications, while at the same time making it easy and/or fast to remove the oil. Nevertheless, it is understood that a maximum depth of the at least one basin measured from the surface of the earth may be even greater than mentioned above. Particularly, if exemplarily the anhydrite layer, as mentioned below, has a sufficient depth.

The oil storage may comprise a first basin and a second basin, wherein the first basin and the second basin may be arranged such that a ratio of S to D is above 2, wherein S represents the distance between a center of the first basin and a center of the second basin and D represents the average of the maximum diameters of the first basin and the second basin and/or such that a ratio of P to D is above 1, wherein P represents the minimum distance between the first basin and the second basin. It has been shown that hereby leaks are prevented from occurring between the first basin and the second basin. Further, it has also been found that this ensures sufficient stability of the side walls of the basins. The center of the first basin may be the centroid of a horizontal cross-sectional surface of the first basin. Accordingly, the center of the second basin may be the centroid of a horizontal cross-sectional surface of the second basin. It is understood that the first basin and the second basin may be adjacent basins. Preferably, all basins of the oil storage are arranged such that the above-mentioned minimum ratios of S to D and/or P to D are fulfilled for any pair of basins.

The oil storage may comprise at least one monitoring well formed into the surface of the salt dome which is at the surface of the earth. Exemplarily, the at least one monitoring well may comprise a hole formed into the surface of the salt dome which is at the surface of the earth and a sensor arranged in this hole. Said hole may be substantially vertical. Further, said at least one monitoring well may be used for observing groundwater levels and flow conditions, obtaining samples for determining groundwater and/or soil quality, and for evaluating hydraulic properties of water-bearing strata. It is to be noted that in practice, monitoring wells are sometimes referred to as “observation wells”. By means of at least one monitoring well, it is possible to monitor whether oil is leaking from the basin. Environmental risks can therefore be reduced or at least controlled. In addition, the groundwater level can be monitored, for example to prevent or at least plan for the ingress of water into the basin from below.

The at least one monitoring well may be arranged adjacent to a corner of the at least one basin, wherein optionally the at least one monitoring well is arranged on a diagonal of the at least one basin. In this regard, it is understood that the at least one basin may be substantially rectangular. The inventors have found that this arrangement makes it possible to monitor the tightness of two adjacent side walls of the at least one basin. Accordingly, the required number of the monitoring wells can thus be kept low.

The oil storage may comprise four monitoring wells, wherein each of these monitoring wells may be arranged adjacent to a corner of the at least one basin, wherein optionally each of these monitoring wells is arranged on one of the two diagonals of the at least one basin. This arrangement has proven to be advantageous in that sufficient monitoring of the area surrounding the at least one basin is achieved with as few monitoring wells as possible.

The oil storage may comprise a plurality of basins for receiving oil, wherein the plurality of basins may be arranged in a grid pattern. A grid pattern is a pattern comprising horizontal and vertical lines crossing each other to form squares. The basins may be arranged on said lines and/or in the formed squares. Using a plurality of basins versus a single basin can ensure redundancy. If, for example, a basin fails due to contamination and/or leakage, oil can continue to be extracted and/or fed from and/or to the remaining basins. Furthermore, it is possible to provide basins with different characteristics. For example, some basins can be optimized for fast removal and/or filling, while other basins can be optimized for the longest possible storage. In addition, arranging the basins in a grid structure allows for easy design of the basins' supply infrastructure.

The oil storage may comprise a plurality of monitoring wells formed into the surface of the salt dome which is at the surface of the earth, wherein the plurality of monitoring wells may be arranged in a grid pattern. Again, a grid pattern is a pattern comprising horizontal and vertical lines crossing each other to form squares. The monitoring wells may be arranged on said lines and/or in the formed squares. Providing a plurality of monitoring wells in a grid pattern enables the plurality of basins that are also arranged in a grid pattern to be comprehensively monitored. It is understood that the grid pattern of monitoring wells preferably overlaps with the grid pattern of basins.

The oil storage may comprise at least one of the following: a valve being configured to regulate a flow from or to the at least one basin; a pump station; an input pipeline, and an output pipeline. These components allow for the oil storage to be integrated into production equipment and/or pipeline systems of oil producers. Thus, the oil storage according to the present invention may be used by oil producers to compensate for temporary overcapacity and/or production shortfalls.

The valve, the pump station, the input pipeline, and/or the output pipeline may be located outside the salt dome, wherein optionally the valve, the pump station, the input pipeline, and/or the output pipeline are not in contact with the salt dome. It has been found that this can extend the shelf life of the aforementioned components. In addition, the maintenance effort may be reduced. Particularly since the corrosion-promoting influence of the salt of the salt dome can be reduced.

Further, at least 5%, optionally at least 10%, and further optionally at least 15% of a total volume of the at least one basin may be filled with oil. In this way, water that collects in at least one basin is always covered by oil. This has various advantages. For example, animals can be prevented from ingesting potentially contaminated water from the basin. In addition, for low temperatures it can be ensured that no ice layer forms.

Moreover, the at least one basin may be open air. In this way, a roof structure can be dispensed with. Accordingly, a particularly simple design of the oil reservoir is possible. However, it goes without saying that rainwater can collect in at least one basin, which then has to be pumped out depending on the filling level of the basin. In rainy areas, a roofing of the basin can still be useful.

The at least one basin may be completely formed by the salt dome. Thus, no inner surface of the at least one basin may be formed by any other than the salt dome. Further, the at least one basin may not be in contact with the material, i.e. soil, surrounding the salt dome. This can ensure that oil is only in contact with the salt dome and contamination of the surrounding material is avoided.

The at least one basin may be formed into an anhydrite layer of the salt dome, wherein optionally the anhydrite layer has a thickness in a range from 50 m to 200 m, further optionally from 60 m to 100 m. Moreover, the salt dome may extend into the earth for at least 8 km. It is understood that the at least one basin may be completely formed by the anhydrite layer. Anhydrite may be referred to as a mineral with the chemical formula CaSO₄. Further, it is known that significant amounts of anhydrite occur when salt domes form a caprock. It has shown that forming the at least one basin into the anhydrite layer of the salt dome increases the stability and/or impermeability of the basin. Particularly, when the at least one basin is completely formed by the anhydrite layer. Moreover, said thicknesses of the anhydrite layer allow for a sufficient safety against leakage of the at least one basin. Furthermore, salt domes with a depth of at least 8 km have been found to be particularly stable, e.g. against vibrations. Moreover, salt domes with a depth of at least 8 km have shown to form sufficiently homogeneous and/or stable anhydrite layers.

The salt dome may prevent oil from seeping into soil. Thus, the oil storage may retain oil permanently and safely for future use. It is understood that the salt dome must have a certain consistency for this purpose. However, it may be determined in tests whether this consistency is present, and the seeping of oil is prevented.

Further, the above object is achieved by a method for developing an oil storage, particularly according to any one of the preceding claims. Since the method according to the present invention may serve to obtain the oil storage according to the present invention it is understood that the advantages and/or features of the oil storage, as described above, may also apply to the method and vice versa. The method comprises the following steps: locating a salt dome that penetrates to the surface of the earth, and forming at least one basin for receiving oil into a surface of the salt dome which is at the surface of the earth. Locating the salt dome may include taking soil samples, conducting seepage tests, and/or applying seismic reflection.

The at least one basin may be formed by mining and/or washing out. Respective advantages and/or features are described above with regards to the oil storage according to the present invention.

The at least one basin may be formed such that a maximum depth of the at least one basin measured from the surface of the earth is in a range from 2 m to 50 m, optionally from 5 m to 30 m, and further optionally from 10 m to 20 m. Respective advantages and/or features are described above with regards to the oil storage according to the present invention.

Further, a first basin for receiving oil and a second basin for receiving oil may be formed into the surface of the salt dome which is at the surface of the earth, wherein the first basin and the second basin may be arranged such that a ratio of S to D is above 2, wherein S represents the distance between a center of the first basin and a center of the second basin and D represents the average of the maximum diameters of the first basin and the second basin and/or such that a ratio of P to D is above 1, wherein P represents the minimum distance between the first basin and the second basin. Respective advantages and/or features are described above with regards to the oil storage according to the present invention.

The method may further comprise the step of forming at least one monitoring well into the surface of the salt dome which is at the surface of the earth. Respective advantages and/or features are described above with regards to the oil storage according to the present invention.

Moreover, the at least one monitoring well may be arranged adjacent to a corner of the at least one basin, wherein optionally the at least one monitoring well is arranged on a diagonal of the at least one basin. Respective advantages and/or features are described above with regards to the oil storage according to the present invention.

Optionally four monitoring wells are formed into the surface of the salt dome which is at the surface of the earth, wherein each of these monitoring wells may be arranged adjacent to a corner of the at least one basin, wherein optionally each of these monitoring wells is arranged on one of the two diagonals of the at least one basin. Respective advantages and/or features are described above with regards to the oil storage according to the present invention.

Further, a plurality of basins for receiving oil may be formed into the surface of the salt dome which is at the surface of the earth, wherein these basins may be arranged in a grid pattern. Respective advantages and/or features are described above with regards to the oil storage according to the present invention.

Furthermore, a plurality of monitoring wells may be formed into the surface of the salt dome which is at the surface of the earth, wherein the plurality of monitoring wells may be arranged in a grid pattern. Respective advantages and/or features are described above with regards to the oil storage according to the present invention.

The method may further comprise the step of providing at least one of the following: a valve being configured to regulate a flow from or to the at least one basin; a pump station; an input pipeline, and an output pipeline. Respective advantages and/or features are described above with regards to the oil storage according to the present invention.

The valve, the pump station, the input pipeline, and/or the output pipeline may be located outside the salt dome, wherein optionally the valve, the pump station, the input pipeline, and/or the output pipeline are not in contact with the salt dome. Respective advantages and/or features are described above with regards to the oil storage according to the present invention.

The method may further comprise the step of filling at least 5%, optionally at least 10%, and further optionally at least 15% of a total volume of the at least one basin with oil. Respective advantages and/or features are described above with regards to the oil storage according to the present invention.

The at least one basin may be open air. Respective advantages and/or features are described above with regards to the oil storage according to the present invention.

The at least one basin may be formed such that it is completely formed by the salt dome. Respective advantages and/or features are described above with regards to the oil storage according to the present invention.

The at least one basin may be formed into an anhydrite layer of the salt dome, wherein optionally the anhydrite layer has a thickness in a range from 50 m to 200 m, further optionally from 60 m to 100 m. Moreover, the salt dome may extend into the earth for at least 8 km. Respective advantages and/or features are described above with regards to the oil storage according to the present invention.

Moreover, the salt dome may prevent oil from seeping into soil. Respective advantages and/or features are described above with regards to the oil storage according to the present invention.

### 4. BRIEF DESCRIPTION OF THE ACCOMPANYING FIGURES

In the following, the accompanying figures are briefly described:

FIG. 1 shows a side section view of an oil storage according to the present invention;

FIG. 2 shows a top view of an oil storage according to the present invention, and

FIG. 3 shows a diagram of a method for developing an oil storage according to the present invention.

### 5. DETAILED DESCRIPTION OF THE FIGURES

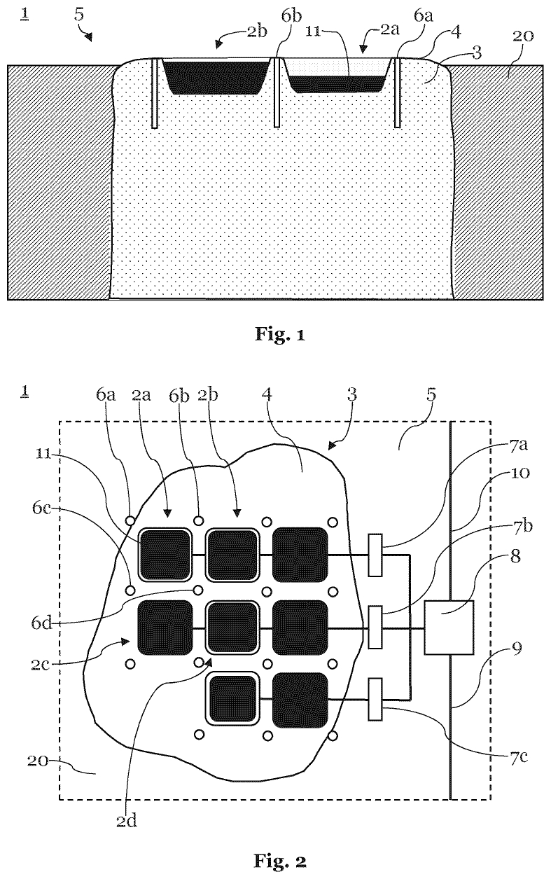

FIG. 1 shows an oil storage 1 that comprises a first basin 2a and a second basin 2b. Both basins 2a, 2b are partially filled with oil 11. The oil storage further comprises a salt dome 3 that penetrates to the surface of the earth 5, wherein the first basin 2a and the second basin 2b are formed into a surface 4 of the salt dome 3 which is at the surface of the earth 5. Thereby, the salt dome 3 prevents oil 11 from seeping into soil.

The oil storage 1 of FIG. 1 comprises three monitoring wells 6a, 6b, 6c formed into the surface 4 of the salt dome 3 which is at the surface of the earth 5. As shown, the monitoring wells 6a, 6b, 6c reach deeper into the earth than the first basin 2a and the second basin 2b. Hence, an area, which is deeper than the basins 2a, 2b may also be monitored.

Moreover, in the oil storage of FIG. 1 at least 15% of a total volume of the first basin 2a and of the second basin 2b are filled with oil 11. This increases the redundancy of the oil storage 1. Exemplarily the second basin 2b may provide in case the first basin 2a has a technical defect.

As depicted in FIG. 1, the first basin 2a and the second basin 2b are both open air. Thereby it is understood that a coverage may be applied over the basins 2a, 2b.

Furthermore, in the oil storage 1 of FIG. 1 both basins 2a, 2b are completely formed by the salt dome 3. Hence, no inner surface of the first basin 2a or the second basin 2b is formed by any other than the salt dome 3.

FIG. 2 shows an oil storage 1, wherein the oil storage 1 comprises a plurality of basins 2a, 2b, 2c, 2d for receiving oil 11. Thereby the plurality of basins 2a, 2b, 2c, 2d are arranged in a grid pattern. Further, as the oil 11 can be seen in the top view of FIG. 2, it is understood that the basin are open air. Moreover, the basins 2a, 2b, 2c, 2d have different fill levels. Exemplarily, the basin 2c is completely filled, whereas the basins 2a, 2b, 2d are not. The oil storage 1 further comprises a salt dome 3 that penetrates to the surface of the earth 5, wherein the plurality of basins 2a, 2b, 2c, 2d are formed into a surface 4 of the salt dome 3 which is at the surface of the earth 5. Said salt dome 3 prevents oil 11 from seeping into soil.

As further depicted in FIG. 2, the oil storage 1 comprises a plurality of monitoring wells 6a, 6b, 6c, 6d formed into the surface 4 of the salt dome 3 which is at the surface of the earth 5. Said plurality of monitoring wells 6a, 6b, 6c, 6d are arranged in a grid pattern. There, the grid pattern of monitoring wells overlaps with the grid pattern of basins. Hence, a reliable monitoring of the basins may be achieved. Further particularly, the oil storage 1 comprises four monitoring wells 6a, 6b, 6c, 6d, wherein each of these monitoring wells 6a, 6b, 6c, 6d is arranged adjacent to a corner of a basin 2a, wherein each of these monitoring wells 6a, 6b, 6c, 6d is arranged on one of the two diagonals of the at least one basin 2a.

Further shown in FIG. 2 is that the oil storage 1 comprises three valves 7a, 7b, 7c being configured to regulate a flow from or to the basins of the oil storage 1. Moreover, the oil storage comprises a pump station 8, an input pipeline 9, and an output pipeline 10. Thereby the valves 7a, 7b, 7c, the pump station 8, the input pipeline 9, and the output pipeline 10 are located outside the salt dome 3, wherein the valves 7a, 7b, 7c, the pump station 8, the input pipeline 9, and/or the output pipeline 10 are not in contact with the salt dome 3. Hence, these components are protected against corrosion. Rather, said components are arranged in or on the material 20 (soil) surrounding the salt dome 3.

As also shown in FIG. 2, the basins 2a, 2b, 20, 2d of the oil storage 1 are completely formed by the salt dome 3. Hence, the basins are not in contact with the material 20 (soil) surrounding the salt dome 3.

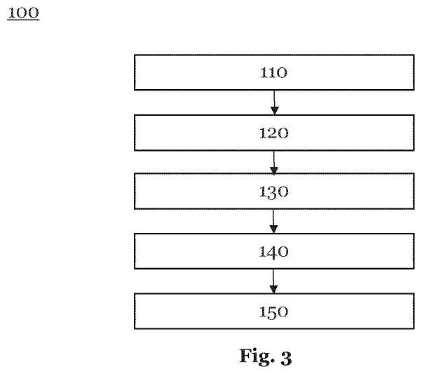

FIG. 3 shows a diagram of a method 100 for developing an oil storage 1, particularly as shown in FIG. 1 and/or FIG. 2. The method 100 comprises the following steps: locating 110 a salt dome 3 that penetrates to the surface of the earth 5, and forming 120 at least one basin 2a for receiving oil 11 into a surface 4 of the salt dome 3 which is at the surface of the earth 5. Thereby the at least one basin 2a may be formed 120 by mining and/or washing out.

The method 100 depicted in FIG. 3 further comprises the step of forming 130 at least one monitoring well 6a into the surface 4 of the salt dome 3 which is at the surface of the earth 5.

Moreover, the method 100 of FIG. 3 further comprises the step of providing 140 at least one of the following: a valve 7a, 7b, 7c being configured to regulate a flow from or to the at least one basin 2a; a pump station 8; an input pipeline 9, and an output pipeline 10.

Furthermore, the method 100 of FIG. 3 comprises the step of filling 150 at least 5% of a total volume of the at least one basin 2a with oil 11.

### List of Reference Signs

1 oil storage
2a, 2b,2c, 2d basin
3 salt dome
4 surface of the salt dome which is at the surface of the earth
5 surface of the earth
6a, 6b, 6c, 6d monitoring well
7a, 7b, 7c valve
8 pump station
9 input pipeline
10 output pipeline
11 oil
20 material surrounding the salt dome
100 method for developing an oil storage
110 locating a salt dome
120 forming at least one basin
130 forming at least one monitoring well
140 providing a valve, a pump station, and/or an input/output pipeline
150 filling the at least one basin

1. An oil storage, wherein the oil storage comprises
at least one basin for receiving oil, and
a salt dome that penetrates to the surface of the earth, wherein the basin is formed into a surface of the salt dome which is at the surface of the earth.

2. The oil storage according to claim 1, wherein the at least one basin was formed by mining and/or washing out.

3. The oil storage according to claim 1, wherein a maximum depth of the at least one basin measured from the surface of the earth is in a range from 2 m to 50 m, optionally from 5 m to 30 m, and further optionally from 10 m to 20 m.

4. The oil storage according to claim 1, wherein the oil storage comprises a first basin and a second basin, wherein the first basin and the second basin are arranged such that
a ratio of S to D is above 2, wherein S represents the distance between a center of the first basin and a center of the second basin and D represents the average of the maximum diameters of the first basin and the second basin and/or
a ratio of P to D is above 1, wherein P represents the minimum distance between the first basin and the second basin.

5. The oil storage according to claim 1, wherein the oil storage comprises at least one monitoring well formed into the surface of the salt dome which is at the surface of the earth.

6. The oil storage according to claim 5, wherein the at least one monitoring well is arranged adjacent to a corner of the at least one basin, wherein optionally the at least one monitoring well is arranged on a diagonal of the at least one basin.

7. The oil storage according to claim 5, wherein the oil storage comprises four monitoring wells, wherein each of these monitoring wells is arranged adjacent to a corner of the at least one basin, wherein optionally each of these monitoring wells is arranged on one of the two diagonals of the at least one basin.

8. The oil storage according to claim 1, wherein the oil storage comprises a plurality of basins for receiving oil, wherein the plurality of basins are arranged in a grid pattern.

9. The oil storage according to claim 8, wherein the oil storage comprises a plurality of monitoring wells formed into the surface of the salt dome which is at the surface of the earth, wherein the plurality of monitoring wells are arranged in a grid pattern.

10. The oil storage according to claim 1, wherein the oil storage comprises at least one of the following:
a valve being configured to regulate a flow from or to the at least one basin;
a pump station;
an input pipeline, and
an output pipeline.

11. The oil storage according to claim 10, wherein the valve, the pump station, the input pipeline, and/or the output pipeline are located outside the salt dome, wherein optionally the valve, the pump station, the input pipeline, and/or the output pipeline are not in contact with the salt dome.

12. The oil storage according to claim 1, wherein at least 5%, optionally at least 10%, and further optionally at least 15% of a total volume of the at least one basin is filled with oil.

13. The oil storage according to claim 1, wherein the at least one basin is open air.

14. The oil storage according to claim 1, wherein the at least one basin is completely formed by the salt dome.

15. The oil storage according to claim 1, wherein the at least one basin is formed into an anhydrite layer of the salt dome, wherein optionally the anhydrite layer has a thickness in a range from 50 m to 200 m, further optionally from 60 m to 100 m, wherein even further optionally the salt dome extends into the earth for at least 8 km.

16. The oil storage according to claim 1, wherein the salt dome prevents oil from seeping into soil.

17. A method for developing an oil storage, particularly according to claim 1, wherein the method comprises the following steps:
locating a salt dome that penetrates to the surface of the earth, and
forming at least one basin for receiving oil into a surface of the salt dome which is at the surface of the earth.

18. The method according to claim 1, wherein the at least one basin is formed by mining and/or washing out.

19. The method according to claim 1, wherein the at least one basin is formed such that a maximum depth of the at least one basin measured from the surface of the earth is in a range from 2 m to 50 m, optionally from 5 m to 30 m, and further optionally from 10 m to 20 m.

20. The method according to claim 1, wherein a first basin for receiving oil and a second basin for receiving oil are formed into the surface of the salt dome which is at the surface of the earth, wherein the first basin and the second basin are arranged such that
a ratio of S to D is above 2, wherein S represents the distance between a center of the first basin and a center of the second basin and D represents the average of the maximum diameters of the first basin and the second basin and/or
a ratio of P to D is above 1, wherein P represents the minimum distance between the first basin and the second basin.

21. The method according to claim 1, wherein the method further comprises the step of
forming at least one monitoring well into the surface of the salt dome which is at the surface of the earth.

22. The method according to claim 21, wherein the at least one monitoring well is arranged adjacent to a corner of the at least one basin, wherein optionally the at least one monitoring well is arranged on a diagonal of the at least one basin.

23. The method according to claim 21, wherein four monitoring wells are formed into the surface of the salt dome which is at the surface of the earth, wherein each of these monitoring wells is arranged adjacent to a corner of the at least one basin, wherein optionally each of these monitoring wells is arranged on one of the two diagonals of the at least one basin.

24. The method according to claim 1, wherein a plurality of basins for receiving oil are formed into the surface of the salt dome which is at the surface of the earth, wherein these basins are arranged in a grid pattern.

25. The method according to claim 24, wherein a plurality of monitoring wells are formed into the surface of the salt dome which is at the surface of the earth, wherein the plurality of monitoring wells are arranged in a grid pattern.

26. The method according to claim 1, wherein the method further comprises the step of providing at least one of the following:
a valve being configured to regulate a flow from or to the at least one basin;
a pump station;
an input pipeline, and
an output pipeline.

27. The method according to claim 26, wherein the valve, the pump station, the input pipeline, and/or the output pipeline are located outside the salt dome, wherein optionally the valve, the pump station, the input pipeline, and/or the output pipeline are not in contact with the salt dome.

28. The method according to claim 1, wherein the method further comprises the step of
filling at least 5%, optionally at least 10%, and further optionally at least 15% of a total volume of the at least one basin with oil.

29. The method according to claim 1, wherein the at least one basin is open air.

30. The method according to claim 1, wherein the at least one basin is formed such that it is completely formed by the salt dome.

31. The method according to claim 1, wherein the at least one basin is formed into an anhydrite layer of the salt dome, wherein optionally the anhydrite layer has a thickness in a range from 50 m to 200 m, further optionally from 60 m to 100 m, wherein even further optionally the salt dome is formed such that it extends into the earth for at least 8 km.

32. The method according to claim 1, wherein the salt dome prevents oil from seeping into soil.
